(19) United States
(12) Patent Application Publication
(10) Pub. No.: US 2026/0192291 A1
(43) Pub. Date: Jul. 9, 2026

(54) METHODS FOR MAKING NANO-SIZED MESOPOROUS ZEOLITE BETA THAT UTILIZE ACID TREATMENTS

(71) Applicant: Saudi Arabian Oil Company, Dhahran (SA)

(72) Inventors: Batool Altaher, Dammam (SA); Lianhui Ding, Dhahran (SA); Faisal Alotaibi, Al Khobar (SA); Mohammed Z. Al-Bahar, Dhahran (SA); Faisal M. Almulla, Dhahran (SA)

(73) Assignee: Saudi Arabian Oil Company, Dhahran (SA)

(21) Appl. No.: 19/009,121

(22) Filed: Jan. 3, 2025

(51) Int. Cl. B01J 37/10; B01J 29/70; B01J 35/45; B01J 35/61; B01J 35/63; B01J 37/00; B01J 37/06; C01B 39/04

(52) U.S. Cl. CPC B01J 37/10; B01J 29/7007; B01J 35/45; B01J 35/617; B01J 35/618; B01J 35/635; B01J 35/638; B01J 37/0018; B01J 37/06; C01B 39/04; B01J 2229/16; B01J 2229/37

(57) ABSTRACT

A method for making nano-sized mesoporous zeolite Beta may include calcining a precursor nano-sized zeolite Beta to form a calcined nano-sized mesoporous zeolite Beta intermediate material. The calcining may be at a temperature of from 400° C. to 650° C. The method may further include contacting the calcined nano-sized mesoporous zeolite Beta intermediate material with an acid to form the nano-sized mesoporous zeolite Beta.

### BACKGROUND

### Field

The present disclosure generally relates to porous materials and, more particularly, to zeolites.

### Technical Background

There are numerous zeolitic materials, which are classified by framework type and composition. Once such zeolitic material is zeolite Beta, which is a type of crystallized aluminosilicate zeolite that is widely used in heavy oil conversion processes such as hydrocracking and fluid catalytic cracking. The feedstock to these processes can be, for example, a portion of crude oil that has an initial boiling point of 350 Celsius (° C.) and an average molecular weight ranging from about 200 to 600, or greater. As such, zeolite Beta has an important use in industry in crude oil refining, and beyond.

### BRIEF SUMMARY

As described herein, conventional nano-sized mesoporous zeolite Beta have been generated where, in some embodiments, a calcining step is utilized. It has been presently discovered that such calcining steps reduce crystallinity of the nano-sized mesoporous zeolite Beta, according to one or more embodiments. Such reduction in crystallinity is undesirable. Embodiments described herein may be utilized to reverse such de-crystallization that is caused by calcining. In particular, treating the nano-sized mesoporous zeolite Beta with an acid following the calcining can, surprisingly, improve crystallization.

In accordance with one embodiment of the present disclosure, a method for making nano-sized mesoporous zeolite Beta my comprise calcining a precursor nano-sized zeolite Beta to form a calcined nano-sized mesoporous zeolite Beta intermediate material. The calcining may be at a temperature of from 400° C. to 650° C. The method may further comprise contacting the calcined nano-sized mesoporous zeolite Beta intermediate material with an acid to form the nano-sized mesoporous zeolite Beta.

Additional features and advantages of the technology disclosed herein will be set forth in the detailed description which follows, and in part will be readily apparent to those skilled in the art from that description or recognized by practicing the technology as described herein, including the detailed description which follows, as well as the appended claims.

It is to be understood that both the foregoing general description and the following detailed description present embodiments of the technology, and are intended to provide an overview or framework for understanding the nature and character of the technology as it is claimed. Additionally, following descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a micrograph of nano-sized zeolite Beta particles, according to one or more examples described in this disclosure; and

FIG. 2 depicts a graph showing ²⁷Al NMR analysis data, according to one or more examples described in this disclosure.

### DETAILED DESCRIPTION

The present disclosure describes various embodiments for making nano-sized mesoporous zeolite Beta that utilize an acid treatment following calcining of a precursor zeolite Beta. In general, and as described herein, the methods for making nano-sized mesoporous zeolite Beta may include an initial step of calcining a precursor nano-sized zeolite Beta to form a calcined nano-sized zeolite Beta intermediate material, and at least a second step of contacting the calcined nano-sized mesoporous zeolite Beta intermediate material with an acid.

Without being bound by any particular theory, it is believed that calcining the precursor nano-sized zeolite Beta creates non-framework aluminum atoms, which is believed to reduce crystallinity of the zeolite Beta. Such a calcining step may be needed to remove organic compounds present in the precursor nano-sized zeolite Beta. Such reduced crystallinity is not desirable, and may cause lower efficiency for catalytic cracking of hydrocarbons. However, it has been presently discovered that a post-calcining acid treatment may increase crystallinity of the nano-sized zeolite Beta as compared with the calcined nano-sized mesoporous zeolite Beta intermediate material. Without being bound by theory, it is believed that the acid treatment removes non-framework aluminum while not appreciably affecting the framework structure of the zeolite, thus, increasing crystallinity. As compared with other conventional methods for making nano-sized mesoporous zeolite having relatively high crystallinity, the presently disclosed methods may be simpler, cheaper, and easier scaled. Additionally, the removal of the non-framework aluminum may increase surface area and/or pore volume.

As used throughout this disclosure, and as would be understood by those skilled in the art, “zeolites” may refer to micropore-containing inorganic materials with regular intra-crystalline cavities and channels of molecular dimension. As is understood by those skilled in the art, and as used in this disclosure, “zeolite Beta” refers to a type of zeolite having a *BEA framework type according to the International Zeolite Association (“IZA”) zeolite nomenclature and consisting majorly of silica and alumina. The molar ratio of silica to alumina in the zeolite Beta may be 5 or greater, 10 or greater, 25 or greater, or even 100 or greater. For example, the molar ratio of silica to alumina in the zeolite Beta may be from 5 to 500, such as from 10 to 50. Silica to Alumina ratio can be measured by X-ray Fluorescence (“XRF”) spectrometry, as would be understood by those skilled in the art.

In one or more embodiments, the zeolites described herein may be “mesoporous zeolites,” which refers to zeolites that have an average pore size of from 2 nm to 50 nm (the mesoporous range as recognized by IUPAC). Zeolites generally comprise a crystalline structure, as opposed to an amorphous structure such as what may be observed in some porous materials such as amorphous silica. Zeolites generally include a microporous framework which may be identified by a framework type. The microporous structure of zeolites (e.g., 0.3 nm to 2 nm pore size) may render large surface areas and desirable size-/shape-selectivity, which may be advantageous for catalysis. In embodiments described herein, the zeolites may include micropores (present in the microstructure of a zeolite), and additionally include mesopores. As used throughout this disclosure, micropores refer to pores in a structure that have a diameter of less than or equal to 2 nm and greater than or equal to 0.1 nm, and mesopores refer to pores in a structure that have a diameter of greater than 2 nm and less than or equal to 50 nm. The average pore size, which is how pore sized is characterized herein unless stated otherwise, may be determined by Brunauer-Emmett-Teller (BET) analysis, which is a classification technique that is well understood by those skilled in the art.

As described herein, “nano-sized” refers to zeolitic particles and/or crystals that have an average particle size of less than or equal to 100 nm, where the average is utilized to classify size since the zeolitic particles, when produced, are generally dispersed in size in a distribution, such as a normal distribution. In some embodiments, the precursor nano-sized mesoporous zeolite Beta, calcined nano-sized mesoporous zeolite Beta intermediate material, and/or the ultimately formed nano-sized mesoporous zeolite Beta may have an average particle size ranging from 10 to 100 nm, such as from 20 nm to 100 nm, from 30 nm to 100 nm, from 40 nm to 100 nm, from 50 nm to 100 nm, from 60 nm to 100 nm, from 70 nm to 100 nm, from 80 nm to 100 nm, from 90 nm to 100 nm, from 10 nm to 80 nm, from 10 nm to 70 nm, from 10 nm to 60 nm, from 10 nm to 50 nm, from 10 nm to 40 nm, from 10 nm to 30 nm, or from 10 nm to 20 nm. The nano-sized zeolite Beta described herein may form as particles that may be generally spherical in shape or irregular globular shaped (that is, non-spherical). In embodiments, the particles have a “particle size” measured as the greatest distance between two points located on a single zeolite particle. For example, the particle size of a spherical particle is equal to its diameter. In other shapes, the particle size is measured as the distance between the two most distant points of the same particle, where these points may lie on outer surfaces of the particle. Average particle size can be determined using Scanning Electron Microscopy (“SEM”), where the particle size is measured as the longest distance in any dimension of a particle.

Without being bound by theory, it is believed that the relatively small particle size allows for easier access by the molecules in heavy oil to active sites on the zeolite. For example, the increased external surface area may be caused by the small particle size, which may increase catalytic activity.

As described herein, in one or more embodiments, a precursor nano-sized zeolite Beta is treated with an acid. As described herein, a “precursor nano-sized zeolite Beta” refers to a nano-sized zeolite Beta that has not yet been calcined following its formation or following any subsequent treatment steps such as hydrothermal treatment. According to embodiments, the precursor nano-sized zeolite Beta may be produced, purchased, or otherwise provided. The precursor nano-sized zeolite Beta may be mesoporous (i.e., having an average pore size of from 2 nm to 50 nm) or may be microporous.

According to one or more embodiments, the precursor nano-sized zeolite Beta may be produced by forming a mixture comprising a templating agent, a silica source material, an alumina source material, and water, and hydrothermally treating the mixture containing at least the templating agent, the silica source material, the alumina source material, and water to form the precursor nano-sized zeolite Beta. As described herein, “hydrothermal treatment” refers to treatment under heat in a humid environment, such as in an autoclave. Such a process may be synonymous with steam treating or autoclaving. Following the hydrothermal treatment, the nano-sized zeolite Beta may be separated from the remaining liquids, washed, and/or dried.

According to some embodiments, the templating agent may be a quaternary ammonium salt such as tetraethylammonium hydroxide (TEAOH). Other contemplated templating agents include, without limitation, tetraethylammonium bromide. In one or more embodiments, the silica source material may comprise sodium silicate, fumed silica, precipitated silica, colloidal silica, silica gels, zeolites, dealuminated zeolites, rice husk, silicon hydroxides, silicon alkoxides, or combinations thereof. In one or more embodiments, the alumina source material may comprise aluminates, alumina (e.g. powdered alumina), aluminum colloids, boehmites, pseudo-boehmites, aluminum hydroxides, aluminum salts, aluminum alkoxides, aluminum wire, alumina gels, zeolites, or combinations thereof.

According to one or more embodiments, the mixture containing at least the templating agent (such as TEAOH), the silica source material, the alumina source material, and water may have a molar ratio of these contents of 1 mole of the alumina source material, from 15 moles to 40 moles of the quaternary ammonium salt (such as from 15 moles to 30 moles, or from 30 moles to 40 moles), from 20 moles to 500 moles of the silica source material (such as from 20 moles to 250 moles, or from 250 moles to 500 moles), and from 500 moles to 1000 moles of water (such as from 500 moles to 750 moles, or from 750 moles to 1000 moles).

In embodiments, the mixture containing at least the quaternary ammonium salt, the silica source material, the alumina source material, and water may be hydrothermally treated (e.g., by autoclave) for 1 to 7 days at, for example, 40 rotations per minute (rpm) to 80 rpm (such as about 60 rpm) at 100° C. to 150° C. (such as from 130° C. to 150° C., or about 140° C.) to form the precursor nano-sized zeolite Beta. The hydrothermal treatment may effectively crystalize the source materials to form the zeolite. Without being bound by theory, the amount of agitation during hydrothermal treatment may affect zeolite particle size.

In some embodiments, prior to hydrothermal treatment, the mixture containing at least the templating agent, the silica source material, the alumina source material, and water may be aged, such as by stirring for 4 hours at room temperature, prior to hydrothermal treatment. It should be understood that the described autoclaving and aging steps may be modified to some degree depending upon the exact components of the mixture that is autoclaved and the desired zeolite crystal structure to be formed.

Following the hydrothermal treatment, the resulting precursor nano-sized zeolite Beta may be separated from the remaining liquids, washed, and/or dried. The separation may be by centrifuge, or any other suitable liquid/solids separation technique. Washing may be with deionized water until the pH level is lower than 9.0. Drying may comprise passive drying or heating in an oven at, for example about 110° C. (such as 50° C. to 150° C.).

According to some embodiments, the formed nano-sized zeolite Beta (formed from the hydrothermal treating described herein) may be further treated by a second hydrothermal treatment or by a base treatment.

In the embodiment that includes a base treatment, the formed mixture containing the nano-sized zeolite crystals is combined with one or more of a base, such as a basic aqueous solution (for example, containing NaOH or ammonia) and cetrimonium bromide (CTAB), forming a second mixture. For example, the base aqueous solution (for example, NaOH or ammonia in water) may be added to the mixture containing the nano-sized zeolite crystals, and then cetrimonium bromide may be subsequently added. In one or more embodiments, the basic aqueous solution concentration may be from 0.05 M to 2 M of the base, and the weight ratio of cetrimonium bromide to zeolite may be from 0.1 to 1.5. This second mixture may then be heated to an elevated temperature for a heating time period to form mesopores in the nano-sized zeolite crystals. For example, the elevated temperature may be from 100° C. to 150° C. and the heating time period may be from 1 to 5 days. The nano-sized zeolite crystals may then be separated from the other contents of the second mixture to produce pure or nearly pure nano-sized, mesoporous zeolite Beta particles suitable for use as the precursor nano-sized zeolite Beta. According to one or more embodiments, the separation may comprise a solids/liquids separation technique (for example, centrifugation, filtering, etc.), followed by washing with water, drying at, for example 100° C. for a period of several hours.

In the embodiment that includes the second hydrothermal treatment, the nano-sized zeolite Beta crystals formed from the first hydrothermal treatment described hereinabove may be subjected to a second hydrothermal treatment step (e.g., by autoclave) for 10 minutes to 5 hours (such from 30 minutes to 2 hours), for example, at 400° C. to 700° C. (such as from 500° C. to 600° C.) to form the precursor nano-sized zeolite Beta. The second hydrothermal treatment may be at substantially higher temperatures than the first hydrothermal treatment. Such a second hydrothermal treatment may increase mesoporosity.

In the embodiments where a second hydrothermal treatment step is utilized and where a base treatment is utilized to from the precursor nano-sized zeolite Beta, a calcining step may take place prior to the second hydrothermal treatment and the base treatment. However, such materials are still considered, as described herein, to be precursor materials since a treatment step follows the calcining. For example, calcining may be at 400° C. to 650° C. for from 2 to 8 hours. As described herein, “calcining” refers generally to heating to elevated temperatures in the presence of oxygen, even if in limited amounts. Calcining can be performed in an oven, kiln, or the like. Calcining is sometimes referred to as calcination, and these terms should be considered as interchangeable in the present disclosure.

As described hereinabove, according to embodiments, the precursor nano-sized zeolite Beta may be calcined at a temperature of from 400° C. to 650° C., such as from 400° C. to 600° C., from 400° C. to 550° C., from 400° C. to 500° C., from 400° C. to 450° C., from 450° C. to 650° C., from 500° C. to 650° C., from 550° C. to 650° C., or from 600° C. to 650° C. The time of calcining may be from 2 hours to 8 hours, such from 2 hours to 6 hours, from 2 hours to 4 hours, from 4 hours to 8 hours, or from 6 hours to 8 hours. The calcining may be at a temperature ramp rate of from 1° C./min to 4° C./min, such as from 2° C./min to 4° C./min, from 3° C./min to 4° C./min, from 1° C./min to 3° C./min, or from 1° C./min to 2° C./min. Such calcining of the precursor nano-sized zeolite Beta may form the calcined nano-sized mesoporous zeolite Beta intermediate material. As described herein, “intermediate material” refers to a material that is later processed, such as by the acid treatment described herein.

Without being bound by theory, the calcining may burn off organic compounds, such as the templating agent, that are within the pores of the zeolite Beta, thus increasing the average pore size as compared, according to some embodiments. However, it is believed that such calcining may cause non-framework aluminum species to form on the calcined nano-sized mesoporous zeolite Beta intermediate material. In particular, without being bound by theory, it is believed that Al species are generated due to dealumination, and some pores or channels are blocked by the species, and that during the calcining of zeolite beta, the templating agent (such as TEAOH) in cages or channels of the zeolite Beta is decomposed. In air, the TEAOH is decomposed via Hoffman elimination reactions: (C₂H₅)₄N⁺OH⁻→C₂H₄+(C₂H₅)₃N+H₂O. Still without being bound by theory, it is believed that produced water becomes steam, and leads to dealumination and partially destroys the zeolite framework structure.

Following the calcining, according to one or more embodiments, the calcined nano-sized mesoporous zeolite Beta intermediate material may be contacted with an acid to form the nano-sized mesoporous zeolite Beta that is the product of the processes described herein. Without being bound by theory, it is believed that contacting of the calcined nano-sized mesoporous zeolite Beta intermediate material with the acid removes a portion or all of the non-framework aluminum present in the calcined nano-sized mesoporous zeolite Beta intermediate material.

According to one or more embodiments, the acid may be present in an aqueous solution, such that the calcined nano-sized mesoporous zeolite Beta intermediate material is contacted with an aqueous solution comprising an acid. As described herein, an “acid” can refer to any compound that forms an acidic environment, especially when introduced into water. In embodiments, the aqueous solution comprising the acid may have a pH of less than 7. In some embodiments, the aqueous solution comprising the acid may have a pH of less than 6, less than 5, less than 4, or even less than 3. The aqueous solution may have a concentration of the acid of from 0.1 M to 2 M, such as from 0.25 M to 0.75 M. In general, greater acidity may speed up the acidic leaching of the non-framework aluminum.

According to embodiments, the acid is not necessarily limited, but may be chosen from hydrochloric acid, acetic acid, nitric acid, citric acid, sulfuric acid, phosphoric acid, formic acid, or a combination thereof.

According to one or more embodiments, the calcined nano-sized mesoporous zeolite Beta intermediate material may be contacted with the acid at or about room temperature, or at elevated temperatures. Such elevated temperatures may speed up the acidic leaching of the non-framework aluminum. For example, the calcined nano-sized mesoporous zeolite Beta intermediate material may contacted with the acid at a temperature of from 20° C. to 90° C. In some embodiments, the calcined nano-sized mesoporous zeolite Beta intermediate material may be contacted with the acid at a temperature of from 45° C. to 90° C. Acid contact time may vary with acidity and temperature. In one or more embodiments, the calcined nano-sized mesoporous zeolite Beta intermediate material may be contacted with the acid for 0.5 hours to 10 hours, such as from 1 hour to 10 hours, from 2 hours to 10 hours, from 5 hours to 10 hours, from 0.5 hours to 5 hours, from 0.5 hours to 2 hours, or from 0.5 hours to 1 hour.

Following the acid treatment, the nano-sized mesoporous zeolite Beta may be separated from the acid, washed, and/or dried. The separation may be by centrifuge, or any other suitable liquid/solids separation technique. Washing may be with deionized water until the pH level is lower than 9.0. Drying may comprise passive drying or heating in an oven at, for example, 100-120° C.

According to embodiments, the presently disclosed methods may not utilize a structure-directing agent, which may be costly and undesirable. Such structure directing agents may be organic nitrogen-containing structure directing agent, such as amines, such as diethylamine or 1,6-diaminohexane, an alkanolamine, such as diethanolamine, 1,8-diamino-octane, N-Ethylpyridine, or a tetraalkyl ammonium compound, such as tetrapropylammonium hydroxide (TPAOH).

As described herein, the crystallinity of the produced nano-sized mesoporous zeolite Beta may be greater than that of the calcined nano-sized mesoporous zeolite Beta intermediate material, and in some embodiment even greater than that of the precursor nano-sized zeolite Beta. According to some embodiments, the produced nano-sized mesoporous zeolite Beta (following acid treatment) may have a relative crystallinity of 2% or more, 5% or more, or even 10% or more, greater than that of the calcined nano-sized mesoporous zeolite Beta intermediate material. In additional embodiments, the formed nano-sized mesoporous zeolite Beta (following acid treatment) has a higher relative crystallinity than the calcined nano-sized mesopores zeolite Beta.

In one or more embodiments, the nano-sized mesoporous zeolite Beta described herein may have an average pore volume of 0.9 mL/g or greater, such as from 0.9 to 3.0 mL/g, from 1 to 3.0 mL/g, from 1.1 to 3.0 mL/g, or from 1.2 to 3.0 mL/g. As used in this disclosure, “pore volume” refers to the total pore volume measured using BET analysis. Without being bound they theory, it is believed that the relatively large pore size (that is, mesoporosity) of the presently described nano-sized mesoporous zeolite Beta and catalysts that include the nano-sized mesoporous zeolite Beta allows for larger molecules to diffuse inside the zeolite, which is believed to enhance the reaction activity and selectivity of the zeolite. With the increased pore size, aromatic containing molecules can more easily diffuse into the zeolite and aromatic cracking may be increased. For example, in some conventional embodiments, the feedstock converted by the zeolites may be vacuum gas oils, light cycle oils from, for example, a fluid catalytic cracking reactor, or coker gas oils from, for example, a coking unit. The molecular sizes in these oils are relatively small compared to those of heavy oils such as crude and atmosphere residue, which may be the feedstock of the presently described methods and systems. The heavy oils generally are not able to diffuse inside the conventional zeolites to be converted on the active sites located inside the zeolites. Therefore, zeolites with larger pore sizes (that is, mesoporous zeolites) may make the larger molecules of heavy oils overcome the diffusion limitation, and may make possible reaction and conversion of the larger molecules of the heavy oils.

In additional embodiments, the nano-sized, mesoporous zeolites described herein may have an average surface area of 600 m²/g or greater, such as from 600 m²/g to 700 m²/g. For example, embodiments of the nano-sized, mesoporous zeolite Beta may have a surface area of from 500 m²/g to 550 m²/g, from 500 m²/g to 600 m²/g, from 500 m²/g to 650 m²/g, from 550 m²/g to 700 m²/g, from 600 m²/g to 700 m²/g, or from 650 m²/g to 700 m²/g. Average surface area can be measured by BET analysis. Increased surface area may increase catalytic effectiveness, and is generally desirable.

According to one or more embodiments, the produced nano-sized, mesoporous zeolites described herein may be utilized in hydrocracking operations. Hydrocracking is a process combining catalytic cracking and hydrogenation, wherein heavier feedstocks are cracked in the presence of hydrogen to produce more desirable products. This is an important technology for producing high-value naphtha or distillate products from a wide range of refinery feedstocks. According to embodiments, hydrocracking catalysts may utilize zeolite Beta as their cracking component. The high acidity and hydrothermal stability of zeolite Beta make it a desirable catalyst component in hydrocracking, fluid catalytic cracking, hydrotreating, and isobutene alkylation.

Several non-limiting technical aspects of the present subject matter, described as Aspects 1-20 below, are disclosed herein.

Aspect 1. A method for making nano-sized mesoporous zeolite Beta, the method comprising: calcining a precursor nano-sized zeolite Beta to form a calcined nano-sized mesoporous zeolite Beta intermediate material, wherein the calcining is at a temperature of from 400° C. to 650° C.; and contacting the calcined nano-sized mesoporous zeolite Beta intermediate material with an acid to form the nano-sized mesoporous zeolite Beta.

Aspect 2. The method of Aspect 1, wherein: the calcining of the precursor nano-sized zeolite Beta forms non-framework aluminum to form on the precursor nano-sized zeolite Beta; and contacting of the calcined nano-sized mesoporous zeolite Beta intermediate material with the acid removes a portion or all of the non-framework aluminum.

Aspect 3. The method of any one or more previous Aspects, wherein the calcined nano-sized mesoporous zeolite Beta intermediate material is contacted with the acid at a temperature of from 20° C. to 90° C.

Aspect 4. The method of any one or more previous Aspects, wherein the calcined nano-sized mesoporous zeolite Beta intermediate material is contacted with the acid at a temperature of from 45° C. to 90° C.

Aspect 5. The method of any one or more previous Aspects, wherein the calcined nano-sized mesoporous zeolite Beta intermediate material is contacted with the acid for 0.5 hours to 10 hours.

Aspect 6. The method of any one or more previous Aspects, wherein the acid is present in an aqueous solution having a pH of less than or equal to 6.

Aspect 7. The method of claim 6, wherein the aqueous solution has a concentration of the acid of from 0.1 M to 1 M.

Aspect 8. The method of any one or more previous Aspects, wherein the acid is chosen from hydrochloric acid, acetic acid, nitric acid, citric acid, sulfuric acid, phosphoric acid, formic acid, or combinations thereof.

Aspect 9. The method of any one or more previous Aspects, further comprising: separating the nano-sized mesoporous zeolite from the acid; washing the nano-sized mesoporous zeolite Beta; and drying the nano-sized mesoporous zeolite Beta.

Aspect 10. The method of any one or more previous Aspects, wherein the calcining is for a time period of from 2 hours to 8 hours.

Aspect 11. The method of any one or more previous Aspects, wherein the calcining is at a temperature ramp rate of from 1° C./min to 4° C./min.

Aspect 12. The method of any one or more previous Aspects, further comprising producing the precursor nano-sized zeolite Beta by a process comprising hydrothermally treating a mixture comprising a templating agent, a silica source material, an alumina source material, and water.

Aspect 13. The method of Aspect 12, wherein the templating agent is tetraethylammonium hydroxide, the silica source material is fumed silica, and the aluminum source material is aluminum powder.

Aspect 14. The method of Aspect 12, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

Aspect 15. The method of Aspect 12, wherein the process for producing the precursor nano-sized zeolite Beta further comprises a second hydrothermal treatment at a temperature of 400° C. or greater, or a base treatment.

Aspect 16. The method of any one or more previous Aspects, wherein the nano-sized mesoporous zeolite Beta has an average particle size of from 10 nm to 100 nm.

Aspect 17. The method of any one or more previous Aspects, wherein the nano-sized mesoporous zeolite Beta has an average surface area of 600 m2/g or greater.

Aspect 18. The method of any one or more previous Aspects, wherein the nano-sized mesoporous zeolite Beta has pore volume of 0.9 ml/g or greater.

Aspect 19. The method of any one or more previous Aspects, wherein the nano-sized mesoporous zeolite Beta has a greater relative crystallinity than the calcined nano-sized mesopores zeolite Beta.

Aspect 20. The method of any one or more previous Aspects, wherein the nano-sized mesoporous zeolite Beta has a greater relative crystallinity than the precursor nano-sized zeolite Beta.

### EXAMPLES

The various embodiments of the methods of the present disclosure will be further clarified by the following examples. The examples are illustrative in nature, and should not be understood to limit the subject matter of the present disclosure.

### Example 1—Preparation of Non-Calcined Nano-Sized Zeolite Beta Samples

Two non-calcined nano-sized zeolite Beta materials were fabricated that were further calcined and treated with acid in later Examples. The two samples were prepared according to embodiments disclosed in Alotaibi et al. “A facile synthesis of hierarchical Nanosized Beta and its application in direct crude oil hydrocracking,” Catalyst Communications 2024, Vol. 187, 106871. A first sample, referred to herein as Sample NanoB, was prepared without hydrothermal treatment following zeolite crystallization, and a second sample, referred to herein as NanoB-HT, was prepared with hydrothermal treatment following zeolite crystallization.

To make Sample NanoB, aluminum metal was dissolved in a TEAOH-containing aqueous solution, resulting in the formation of a transparent solution. Subsequently, this solution was introduced into a slurry composed of fumed silica and another portion of the TEAOH-containing aqueous solution. The silica source used was fumed silica (Degussa, Aerosil 200), whereas aluminum source employed was aluminum powder. Additionally, tetraethylammonium hydroxide (TEAOH) (Aldrich, 35% aqueous solution) was utilized as the templating agent. The precursor gel was composed of oxides with the following molar ratio: 30TEAOH:50SiO₂:Al₂O₃:750H₂O. The aluminosilicate fluid gel that was created was agitated in a beaker at room temperature for 4 hours. Following, it was placed into a Teflon-lined autoclave. The process of crystallization was conducted at a temperature of 140° C. in a rotational state at a speed of 60 rpm for 3 days. The autoclave was subjected to quenching to stop the crystallization reaction. The separation of the finished product from the liquid was achieved by using a centrifuge operating at a speed of 16,000 rpm. Subsequently, the separated product underwent a washing process using deionized water until the pH level reached a value lower than 9.0. Finally, the product was subjected to a drying procedure in an oven at a temperature of 110° C.

To make Sample NanoB-HT, the sample NanoB was hydrothermally treated. Specifically, the Sample NanoB was steamed using an autoclave reactor at a temperature 550° C. for one hour and the pressure was maintained at 0.1 MPa throughout the treatment time by adjusting the pressure relief valve.

The produced samples were analyzed for various properties, shown in Table 1. Surface area, pore volume, and average pore size were determined by Brunauer-Emmett-Teller (“BET”) analysis, and molar ratio of silica to alumina was determined by ²⁷Al NMR. Relative crystallinity was determined by X-ray Diffraction (“XRD”) with the sample NanoB being the baseline at “100%” crystallinity, to which all other samples were compared. The relative crystallinity of the various zeolite Betas were analyzed by XRD using a diffractometer, such as a Rigaku Ultima IV multi-purpose diffractometer with a copper X-ray tube available from Rigaku Corporation of Tokyo, Japan. The scanning range was set between 2° to 50° in 20 Bragg-angles with a step size of 0.04° and a total counting time of 1° per minute. The crystallinity percentage was calculated by PANalytical High Score Plus software available from Malvern Panalytical of Mavern, Worcestershire, United Kingdom, through the comparison of the area under the most intense diffraction peaks to that of patterns of a reference zeolite beta.

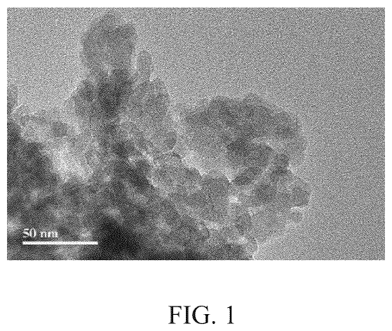

Additionally, both Samples NanoB and NanoB-HT were observed to be particles having diameters of about 30 nm. FIG. 1 depicts a TEM image of such particles.

### Example 2—Calcination of Non-Calcined Nano-Sized Zeolite Beta Samples

In Example 2, Samples NanoB and NanoB-HT were calcined. Specifically, each of Samples NanoB and NanoB-HT were calcined at 600° C. for 4 hours to remove the organic agents (e.g., the TEAOH). The resultant product formed from calcining Sample NanoB is referred to herein as Sample NanoB-C, and the resultant product formed from calcining Sample NanoB-HT is referred to herein as Sample NanoB-HT-C.

The produced samples NanoB-C and NanoB-HT-C were analyzed for various properties, shown in Table 1. Again, relative crystallinity for samples NanoB-C and NanoB-HT-C is compared with the baseline 100% for sample NanoB.

Notably, it is seen that calcining in each sample caused substantial loss in crystallinity. For example, crystallinity in Sample NanoB when calcined was reduced from 100% to 90%, and crystallinity in Sample NanoB-HT when calcined was reduced from 117% to 84%.

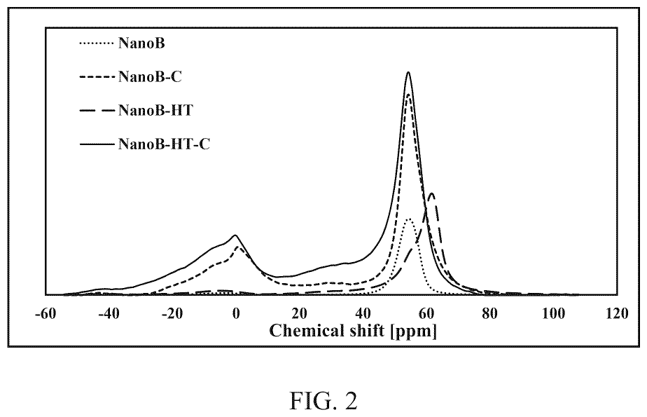

Additionally, now referring to FIG. 2, results of a ²⁷Al NMR analysis conducted on Samples NanoB, NanoB-C, NanoB-HT, and NanoB-HT-C are depicted. From ²⁷Al NMR, it can be concluded that, after Sample NanoB steam treatment, no peaks are observed at chemical shift of 0 ppm, indicating that no non-framework Al species are generated. However, for Sample NanoB and Sample NanoB-HT, after calcination, a considerable amount of non-framework Al species are produced in samples NanoB-C and NanoB-HT-C (evidenced by high peaks at 0 ppm).

TABLE 1

| Sample | NanoB | NanoB-C | NanoB-HT | NanoB-HT-C |
|---|---|---|---|---|
| Description | Non-Calcined | Calcined NanoB | Hydrothermally | Hydrothermally |
| | Nano-sized Zeolite | | Treated NanoB | Treated and |
| | Beta | | | Calcined NanoB |
| Relative | 100% | 90% | 117% | 84% |
| Crystallinity | | | | |
| SiO₂/Al₂O₃ | 22.8 | 22.9 | 22.9 | 22.8 |
| Molar Ratio | | | | |
| Surface area, | 590 | 547 | 411 | 501 |
| m²/g | | | | |
| Pore volume, | 0.83 | 1.15 | 1.01 | 1.13 |
| ml/g | | | | |
| Average pore | 2.8 | 8.3 | 9.8 | 9 |
| size, nm | | | | |

### Example 3—Acid Treatment of Calcined Nano-Sized Zeolite Beta Samples

In Example 3, Samples NanoB-C and NanoB-HT-C were treated with various acidic compounds and temperatures. Specifically, for the acid treatment, 4 g of Sample NanoB-C or NanoB-HT-C were added to a beaker, and then, 40 ml of 0.5 M of an acid was added to the beaker. The mixture was heated for a specified time and temperature. Following this acid treatment, the samples were washed three times, and lastly, the solid products were dried in an oven at 110° C. overnight. Five samples were made, shown in Table 2, which shows the starting material (NanoB-C or NanoB-HT-C), the acid compound utilized, and the time and temperature of acid treatment. Additionally, the formed samples were analyzed for various properties, shown in Table 2. For crystallinity, the percentage is again based on the difference from Sample Nano-B.

TABLE 2

| Sample | NanoB-C-1 | NanoB-C-2 | NanoB-C-3 | NanoB-HT-C-1 | NanoB-HT-C-2 |
|---|---|---|---|---|---|
| Starting zeolite | NanoB-C | NanoB-C | NanoB-C | NanoB-HT-C | NanoB-HT-C |
| Acidic | Hydrochloric | Acetic Acid | Nitric Acid | Hydrochloric | Acetic Acid |
| Compound | Acid | | | Acid | |
| Surface area, | 650 | 630 | 609 | 560 | 587 |
| m²/g | | | | | |
| Pore volume, | 1.22 | 1.31 | 1.24 | 1.3 | 1.32 |
| ml/g | | | | | |
| Average pore | 7.5 | 8.3 | 8.1 | 9.3 | 9 |
| size, nm | | | | | |
| Crystallinity | 99% | 101% | 95% | 92% | 101% |
| SiO₂/Al₂O₃ | 27.5 | 28.6 | 26.4 | 31.2 | 30.5 |
| molar ratio | | | | | |

Notably, it is seen that that acid treatment in each sample caused substantial gain in crystallinity. For example, crystallinity in Sample NanoB-C when acid treated was raised from 90% to 99% in Sample NanoB-C-1, from 90% to 101% in Sample NanoB-C-2, and from 90% to 95% in Sample NanoB-C-3. Additionally, crystallinity in Sample NanoB-HT-C when acid treated was raised from 84% to 92% in Sample NanoB-HT-C-1, and from 84% to 101% in Sample NanoB-HT-C-2. Additionally, pore volume and pore size were substantially increased via acid treatment.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method for making nano-sized mesoporous zeolite Beta, the method comprising:
calcining a precursor nano-sized zeolite Beta to form a calcined nano-sized mesoporous zeolite Beta intermediate material, wherein the calcining is at a temperature of from 400° C. to 650° C.; and
contacting the calcined nano-sized mesoporous zeolite Beta intermediate material with an acid to form the nano-sized mesoporous zeolite Beta.

2. The method of claim 1, wherein:
the calcining of the precursor nano-sized zeolite Beta forms non-framework aluminum to form on the precursor nano-sized zeolite Beta; and
contacting of the calcined nano-sized mesoporous zeolite Beta intermediate material with the acid removes a portion or all of the non-framework aluminum.

3. The method of claim 1, wherein the calcined nano-sized mesoporous zeolite Beta intermediate material is contacted with the acid at a temperature of from 20° C. to 90° C.

4. The method of claim 1, wherein the calcined nano-sized mesoporous zeolite Beta intermediate material is contacted with the acid at a temperature of from 45° C. to 90° C.

5. The method of claim 1, wherein the calcined nano-sized mesoporous zeolite Beta intermediate material is contacted with the acid for 0.5 hours to 10 hours.

6. The method of claim 1, wherein the acid is present in an aqueous solution having a pH of less than or equal to 6.

7. The method of claim 6, wherein the aqueous solution has a concentration of the acid of from 0.1 M to 1 M.

8. The method of claim 1, wherein the acid is chosen from hydrochloric acid, acetic acid, nitric acid, citric acid, sulfuric acid, phosphoric acid, formic acid, or combinations thereof.

9. The method of claim 1, further comprising:
separating the nano-sized mesoporous zeolite from the acid;
washing the nano-sized mesoporous zeolite Beta; and
drying the nano-sized mesoporous zeolite Beta.

10. The method of claim 1, wherein the calcining is for a time period of from 2 hours to 8 hours.

11. The method of claim 1, wherein the calcining is at a temperature ramp rate of from 1° C./min to 4° C./min.

12. The method of claim 1, further comprising producing the precursor nano-sized zeolite Beta by a process comprising hydrothermally treating a mixture comprising a templating agent, a silica source material, an alumina source material, and water.

13. The method of claim 12, wherein the templating agent is tetraethylammonium hydroxide, the silica source material is fumed silica, and the aluminum source material is aluminum powder.

14. The method of claim 12, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

15. The method of claim 12, wherein the process for producing the precursor nano-sized zeolite Beta further comprises a second hydrothermal treatment at a temperature of 400° C. or greater, or a base treatment.

16. The method of claim 1, wherein the nano-sized mesoporous zeolite Beta has an average particle size of from 10 nm to 100 nm.

17. The method of claim 1, wherein the nano-sized mesoporous zeolite Beta has an average surface area of 600 m²/g or greater.

18. The method of claim 1, wherein the nano-sized mesoporous zeolite Beta has pore volume of 0.9 ml/g or greater.

19. The method of claim 1, wherein the nano-sized mesoporous zeolite Beta has a greater relative crystallinity than the calcined nano-sized mesopores zeolite Beta.

20. The method of claim 1, wherein the nano-sized mesoporous zeolite Beta has a greater relative crystallinity than the precursor nano-sized zeolite Beta.
